(19) United States
(12) Patent Application Publication
(10) Pub. No.: US 2026/0242043 A1
(43) Pub. Date: Aug. 20, 2026

(54) Movable Structure

(71) Applicant: NJS Co., Ltd., Tokyo (JP)

(72) Inventors: Yusuke Inagaki, Osaka (JP); Hiroshi Ikeda, Osaka (JP); Ryosuke Otomo, Tokyo (JP); Patrik Ken Takeuchi, Kanagawa (JP); Keita Takagi, Kanagawa (JP); Shuji Ogai, Osaka (JP)

(21) Appl. No.: 18/842,678

(22) PCT Filed: Jul. 25, 2023
(86) PCT No.: PCT/JP2023/027155

§ 371 Date: Aug. 29, 2024

(51) Int. Cl. B63H 7/02; B63H 25/42

(52) U.S. Cl. CPC B63H 7/02; B63H 25/42

(57) ABSTRACT

A movable structure 1 comprises: a structure body 2 floatable on a water surface WS; a fan 6 provided on the structure body 2 and capable of generating an airstream directed outwardly from the structure body 2 in a width direction of the structure body 2; and a guide surface 72a provided on the structure body 2 and configured to guide the airstream generated by the fan 6. The guide surface 72a is disposed at a position offset from a center point CP of the structure body 2 in the width direction, and configured to change a traveling direction of the airstream generated by the fan 6 to increase an upward directivity of the airstream.

### TECHNICAL FIELD

The present invention relates to a movable structure configured to move on a water surface.

### BACKGROUND ART

Movable structures have been known which are configured to perform various works while moving on a water surface. For example, there have been a proposed movable structure equipped with devices such as a camera and a sensor, and used in inspection of a sewer pipe, and a movable structure used for seed dispersal.

Patent Document 1 discloses a movable structure comprising: a buoyant body floatable on a water surface; and a plurality of propellers provided on an upper surface of the buoyant body. Specifically, this movable structure is provided with: four propellers each having an axis parallel to a front-rear direction of the movable structure; and two propellers each having an axis orthogonal to the front-rear direction of the movable structure. The movable structure obtains a propulsive force in the front-rear direction by rotating the former propellers, and obtains a propulsive force in a width direction by rotating the latter propellers.

### CITATION LIST

### Patent Document

Patent Document 1: Japanese Unexamined Patent Application Publication No. 2021-24501 A

### SUMMARY OF INVENTION

### Technical Problem

The movable structure described in the Patent Document 1 receives large resistance from water when moving in the width direction. This leads to a problem of requiring time to move in the width direction, resulting in deteriorated work efficiency.

Further, an airstream generated by the rotation of each propeller travels ahead while spreading. When this airstream reaches the water surface, the water surface is ruffled, possibly causing scattering of water droplets. If a camera, a sensor or the like provided on the movable structure is splashed by water, its operation can be hindered, so that the movable structure is likely to fail to perform an intended work adequately.

The present invention has been made to solve such problems, and an object thereof is to provide a movable structure capable of quickly moving in a width direction, while suppressing water splashing against a device provided on a structure body of the movable structure.

### Solution to Technical Problem

In order to achieve the above object, a movable structure configured to move on a water surface, comprises: a structure body floatable on the water surface; a fan provided on the structure body and capable of generating an airstream directed outwardly from the structure body in a width direction of the structure body; and a guide surface provided on the structure body and configured to guide the airstream generated by the fan to thereby receive a reaction force, the guide surface being disposed at a position offset from a center point of the structure body in the width direction, and configured to change a traveling direction of the airstream generated by the fan to increase an upward directivity of the airstream.

In the above movable structure, the fan may comprise: a propeller configured to rotate about an axis; and a duct covering a periphery of the propeller.

The above movable structure may further comprise an angle adjustment mechanism configured to enable the fan to be turned with respect to the structure body to thereby adjust an angle formed between the width direction and an axis of the fan.

In the above movable structure, the fan may be provided plurally, and the angle adjustment mechanism may be provided plurally, wherein: the plural fans include a first fan disposed on a front end side of the structure body with respect to the center point of the structure body, and a second fan disposed on a rear end side of the structure body with respect to the center point of the structure body; and the plural angle adjustment mechanisms include a first angle adjustment mechanism for adjusting an angle formed between the width direction and an axis of the first fan, and a second angle adjustment mechanism for adjusting an angle formed between the width direction and an axis of the second fan, independently of the first angle adjustment mechanism.

The above movable structure may further comprise a fan casing which includes the guide surface, and fixes the fan to make up a fan unit, wherein the angle adjustment mechanism is configured to enable the fan unit to be turned with respect to the structure body.

In the above movable structure, the fan casing may be configured to cover a periphery of a pathway between the fan and the guide surface.

### Advantageous Effects of Invention

The present invention makes it possible to provide a movable structure capable of quickly moving in a width direction, while suppressing water splashing against a device provided on a structure body of the movable structure.

### BRIEF DESCRIPTION OF DRAWINGS

FIG. 1 is a perspective view showing a movable structure according to a first embodiment.

FIG. 2 is a top plan view showing the movable structure in FIG. 1.

FIG. 3 is a side view showing the movable structure in FIG. 1.

FIG. 4 is a front view showing the movable structure in FIG. 1.

FIG. 5 is an exploded perspective view showing a fan unit in FIG. 1.

FIG. 6 is a sectional view showing a cut surface taken along the line VI-VI in FIG. 1.

FIG. 7 is a top plan view showing the movable structure in FIG. 1.

FIG. 8 is a top plan view showing the movable structure in FIG. 1.

FIG. 9 is an explanatory diagram showing the movable structure in FIG. 1, which is moving rightwardly.

FIG. 10 is a perspective view showing a movable structure according to a second embodiment.

### DESCRIPTION OF EMBODIMENTS

### First Embodiment

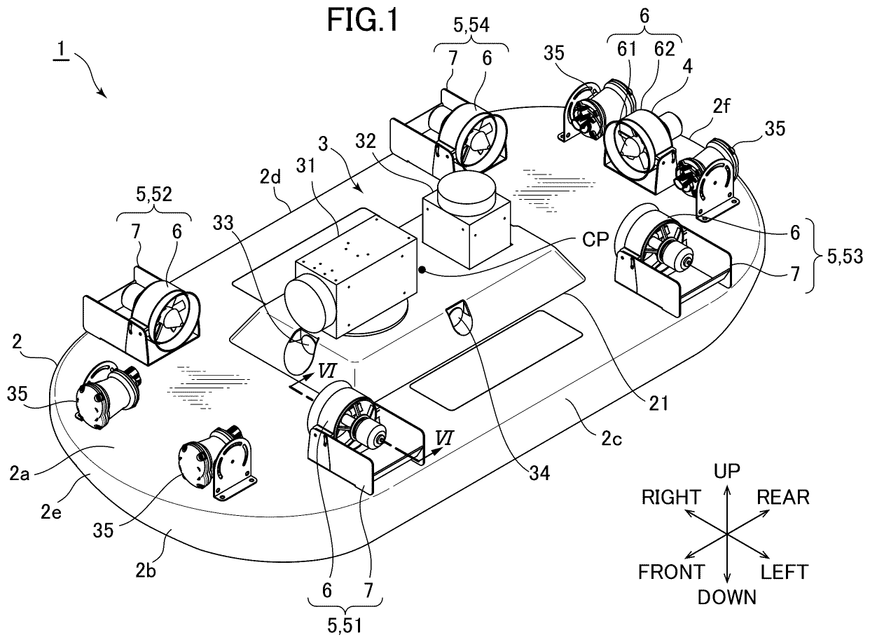

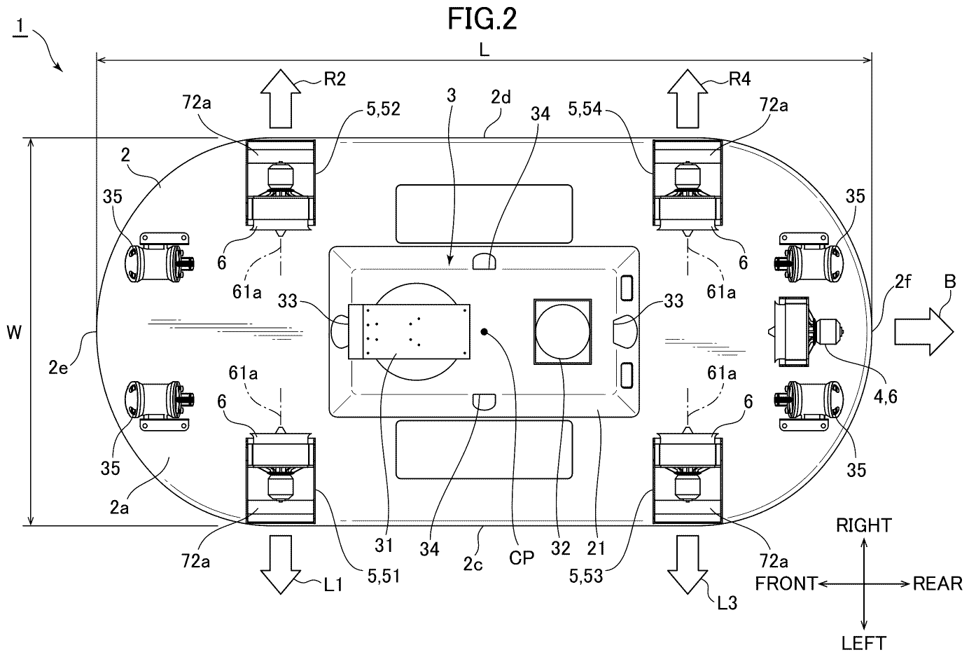

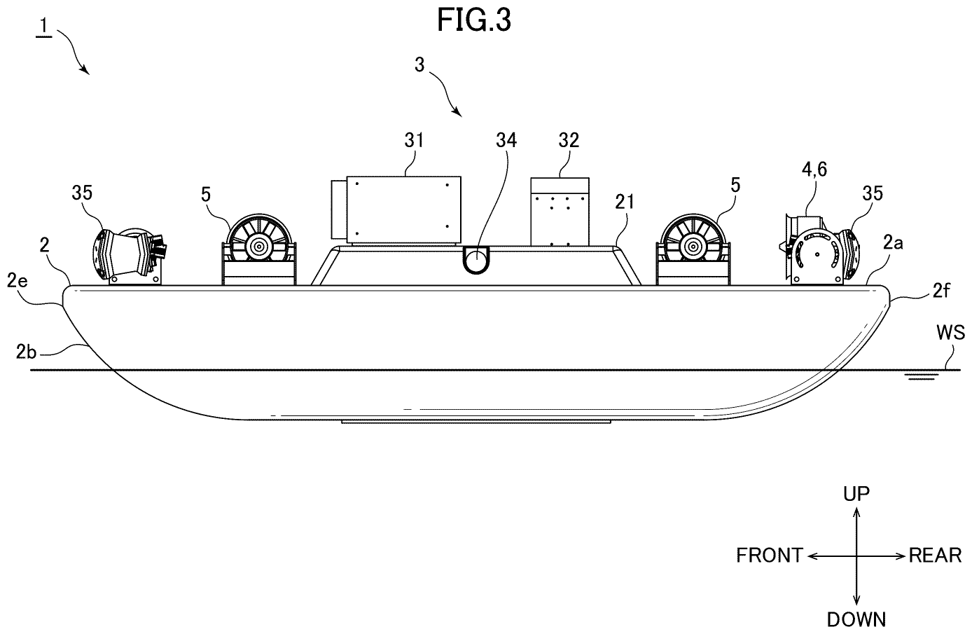

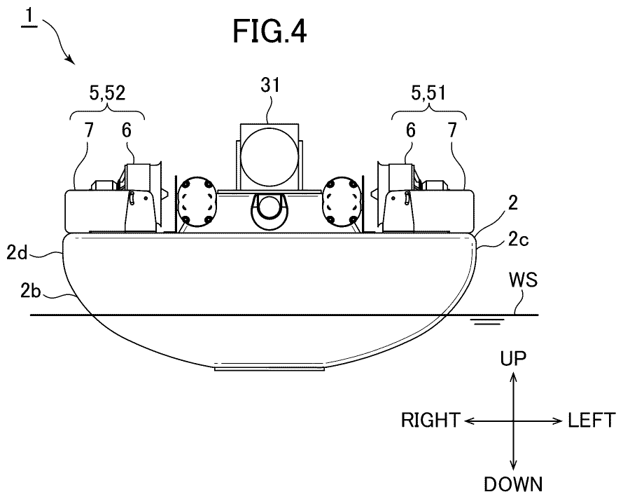

With reference to FIGS. 1-4, the configuration of a movable structure 1 according to a first embodiment will be described. FIG. 1 is a perspective view showing the movable structure 1 as viewed obliquely from the front side thereof. FIG. 2, FIG. 3, and FIG. 4 are, respectively, a top plan view, a side view, and a front view, each showing the movable structure 1.

In this specification, the left and right sides when facing the front of the movable structure 1 disposed on a water surface are referred to respectively as “left” and “right”. The right-left direction is coincident with a width direction of the after-mentioned structure body 2. Further, an upward direction in a vertical direction is referred to as “up”, and a downward direction in the vertical direction is referred to as “down”.

The movable structure 1 is used to acquire information about a non-illustrated sewer pipe. The movable structure 1 has a front-rear directionally-long shape so that it can easily move along a direction in which the sewer pipe extends. Specifically, as shown in FIG. 2, a width W which is a distance between a left end 2c and a right end 2d of the after-mentioned structure body 2 is less than a length L which is a distance between a front end 2e and a rear end 2f of the after-mentioned structure body 2. A center point CP is located at the center in the right-left direction and a front-rear direction of the after-mentioned structure body 2.

The movable structure 1 comprises a structure body 2, an information acquisition device 3, a forward propulsion fan 4, and four fan units 5.

The structure body 2 is formed of a lightweight and highly-rigid material (e.g., carbon fiber-reinforced plastic). The structure body 2 has a raised portion 21 formed in a central region of an upper surface 2a thereof such that it rises upwardly. As shown in FIGS. 3 and 4, a side surface 2b of the structure body 2 extends downwardly from the edge of the upper surface 2a, and front-rear directional and right-left directional dimensions of the side surface 2b become gradually smaller downwardly. The structure body 2 is internally formed with a non-illustrated accommodation space, and electrical components, such as a battery, a control device, and a wireless communication device, are housed in the accommodation space. The structure body 2 is floatable on a water surface WS, in a state in which it houses the electrical components, and mounts the information acquisition device 3, the forward propulsion fan 4, and the fan units 5 each described in detail below.

The information acquisition device 3 is provided to acquire information about a target object around the movable structure 1. As shown in FIG. 2, the information acquisition device 3 comprises a forward camera 31, an upward camera 32, two FPV cameras 33, two ToF sensors 34, and four lights 35.

Each of the forward camera 31 and the upward camera 32 is provided on an upperface of the raised portion 21 of the structure body 2. The forward camera 31 is disposed such that an imaging range thereof is oriented forwardly, and the upward camera 32 is disposed such that an imaging range thereof is oriented upwardly.

The two FPV cameras 33 are provided on front and back sidefaces of the raised portion 21, respectively. The FPV camera 33 provided on the front sideface of the raised portion 21 is disposed such that an imaging range thereof is oriented forwardly, and the FPV camera 33 on the back sideface of the raised portion 21 is disposed such that an imaging range thereof is oriented rearwardly. The two ToF sensors 34 are provided on left and right sidefaces of the raised portion 21, respectively. The ToF sensor 34 provided on the left sideface of the raised portion 21 is disposed such that a measurement range thereof is oriented leftwardly, and the ToF sensor 34 on the right sideface of the raised portion 21 is disposed such that a measurement range thereof is oriented rightwardly.

Each of the lights 35 is a lighting device including a light-emitting diode, and is provided on the upper surface 2a of the structure body 2. Two of the lights 35 are disposed in the vicinity of the front end 2e of the structure body 2 such that they emit light forwardly. Further, the remaining two lights 35 are disposed in the vicinity of the rear end 2f of the structure body 2 such that they emit light rearwardly.

The forward propulsion fan 4 is provided on the upper surface 2a of the structure body 2 in a region adjacent to the rear end 2f of the structure body 2. As shown in FIG. 1, the forward propulsion fan 4 comprises a propeller 61 and a duct 62. The forward propulsion fan 4 is configured to be driven in response to receiving a control signal, to blow out air.

The four fan units 5 are provided on the upper surface 2a of the structure body 2. More specifically, as shown in FIG. 2, two fan units 51, 52 are disposed on the front end 2e side with respect to the center point CP, and two fan units 53, 54 are disposed on the rear end 2f side with respect to the center point CP. Further, two fan units 51, 53 are disposed on the left end 2c side with respect to the center point CP, and two fan units 52, 54 are disposed on the right end 2d side with respect to the center point CP.

### <Configuration of Fan Unit>

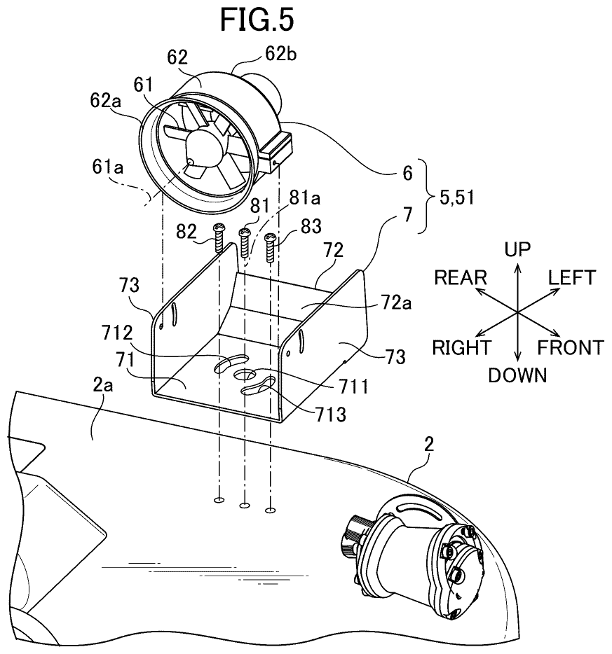

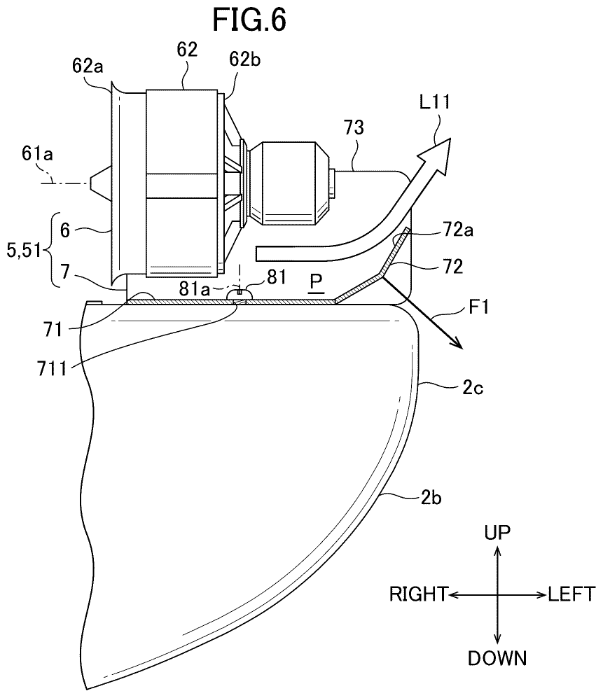

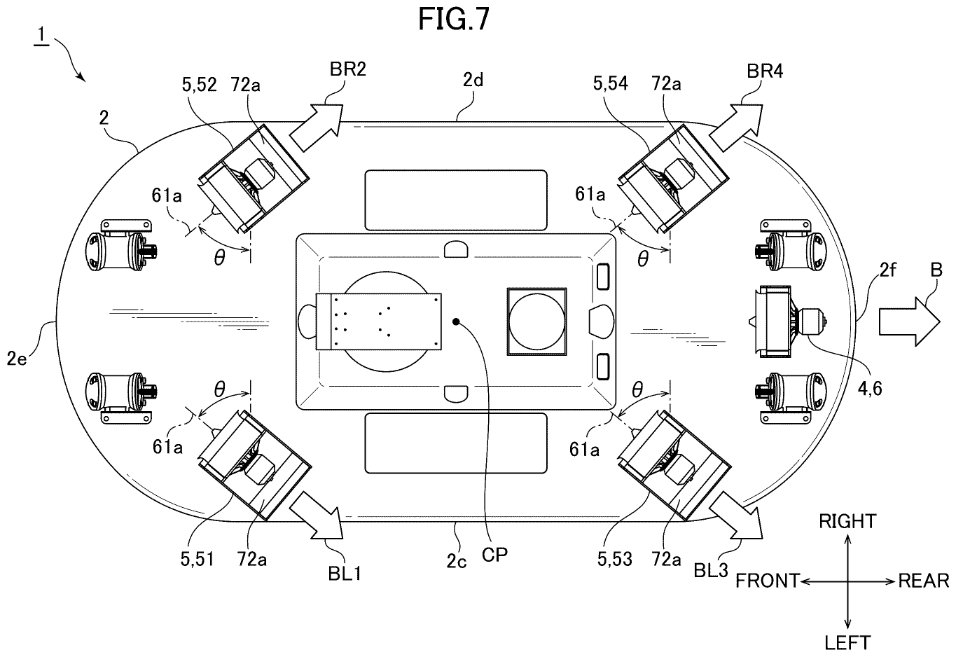

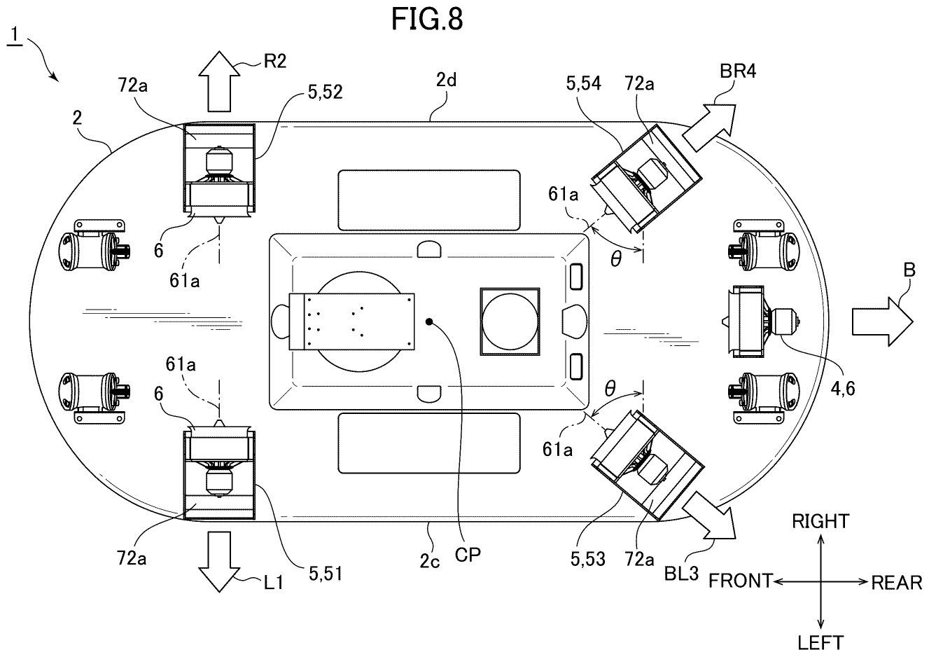

Next, while also referring to FIGS. 5-8, the configuration of the fan unit 5 will be described. FIG. 5 is an exploded perspective view showing the fan unit 5. FIG. 6 is a sectional view showing a cut surface taken along the line VI-VI in FIG. 1, wherein only the after-mentioned fan casing 7 is shown in a sectional view. Each of FIGS. 7 and 8 is a top plan view showing the movable structure 1.

As shown in FIG. 5, the fan unit 5 comprises a fan 6 and a fan casing 7.

The fan 6 comprises a propeller 61 and a duct 62. The propeller 61 comprises a plurality of blades extending radially about an axis 61a, and is configured to be rotatable about the axis 61a. The duct 62 has a hollow cylindrical shape extending approximately linearly between an inlet 62a and an outlet 62b thereof. The duct 62 is disposed to cover the propeller 61 while a central axis thereof is aligned with the axis 61a of the propeller 61. The aforementioned forward propulsion fan 4 has the same configuration as that of the fan 6. The fan 6 of each of the fan units 51, 52 is one example of the “first fan” of the present invention, and the fan 6 of each of the fan units 53, 54 is one example of the “second fan” of the present invention.

As shown in FIGS. 5 and 6, the fan casing 7 has a bottom plate 71, a curved plate 72, and a pair of side plates 73. The bottom plate 71 has a rectangular shape in top plan view. The curved plate 72 extends from one end of the bottom plate 71 while gradually curving upwardly, and has a guide surface 72a. As shown in FIG. 2, the guide surface 72a is disposed at a position offset from the center point CP of the structure body 2 in the right-left direction. In other words, the guide surface 72a is not present on a non-illustrated straight line extending in the front-rear direction while passing through the center point CP. As shown in FIG. 5, the pair of side plates 73 are arranged to be opposed to each other across the bottom plate 71 and the curved plate 72.

The bottom plate 71 is formed with holes 711-713 each penetrating through the bottom plate 71. The hole 711 is formed in a central area of the bottom plate 71. Each of the holes 712, 713 is an elongate hole, and extends around the hole 711 in an arc shape in top plan view. More specifically, the hole 712 extends from one side of the hole 711 toward the curved plate 72, and the hole 713 extends from the other side of the hole 711 toward the side opposite to the curved plate 72. Two elongate holes (not illustrated) of the fan casing 7 of each of the fan units 52, 54 extend in respective directions opposite to the extension directions of the holes 712, 713 of the fan casing 7 of each of the fan units 51, 53.

The fan 6 is fixed to the fan casing 7. More specifically, the fan 6 is disposed between the pair of side plates 73, and is fixed to the side plates 73. As shown in FIG. 6, the fan 6 is disposed such that it is spaced apart from the guide surface 72a of the curved plate 72, and the outlet 62b of the duct 62 is oriented toward the guide surface 72a. Thus, the periphery of a pathway P between the fan 6 and the guide surface 72a is covered by the pair of side plates 73.

The fan unit 5 is mounted to the upper surface 2a of the structure body 2 by screws 81-83 illustrated in FIG. 5. The screw 81 is inserted through the hole 711 of fan casing 7, and the screws 82, 83 are inserted through the holes 712, 713, respectively.

The holes 711-713 and the screws 81-83 are one example of the “angle adjustment mechanism” of the present invention. By providing the angle adjustment mechanism, it becomes possible to turn the fan unit 5 with respect to the structure body 2 within a given range. More specifically, it is possible to turn the fan unit 5 about an axis 81a of the screw 81 to the extent that each of the holes 712, 713 is slidable with respect to a corresponding one of the screws 82, 83. This make it possible to adjust an angle formed by the axis 61a of the propeller 61 with respect to the right-left direction in a range between 0° (see FIGS. 2) and 0 (see FIG. 7; 0 is 45°, for example). An inspector can adjust this angle by turning the fan unit 5 with his/her fingers. Alternatively, a configuration may be employed in which a non-illustrated motor for driving the angle adjustment mechanism is mounted on the movable structure 1, and the above angle is adjusted by driving the motor according to the behavior of the movable structure 1 and the flow of water in the sewer pipe.

The angle adjustment mechanism is provided in each of the fan units 51-54. Thus, the angle of each of the fan units 51-54 can be adjusted in a mutually independent manner. For example, as shown in FIG. 8, each of the fan units 53, 54 can be disposed such that the axis 61 a thereof forms an angle θ with respect to the right-left direction, while each of the fan units 51, 52 is disposed such that the axis 61a thereof is parallel to the right-left direction. The angle adjustment mechanism provided in each of the fan units 51, 52 is one example of the “first angle adjustment mechanism” of the present invention, and the angle adjustment mechanism provided in each of the fan units 53, 54 is one example of the “second angle adjustment mechanism” of the present invention.

### <Inspection of Inside of Sewer Pipe Using Movable Structure>

Next, the inspection of the inside of a sewer pipe using the movable structure 1 will be described. An inspector who conducts an inspection using the movable structure 1 manipulates the movable structure 1 using a non-illustrated remote controller. Upon accepting the manipulation of the inspector, the remote controller wirelessly transmits a manipulation signal corresponding to the manipulation to the outside. In the movable structure 1, the wireless communication device receives this manipulation signal, and the control device sends control signals to the information acquisition device 3, the forward propulsion fan 4, and the fan units 5.

In response to receiving the control signal, the forward propulsion fan 4 is driven such that the propeller 61 (see FIG. 1) is rotated at a speed corresponding to the control signal. The propeller 61 draws air through the inlet 62a of the duct 62 and blows out the air from the outlet 62b of the duct 62. FIGS. 2, 7, and 8 show an airstream B which can be formed by the forward propulsion fan 4. The movable structure 1 can move forwardly using a reaction force acting on the forward propulsion fan 4 as a propulsive force.

During the movement of the movable structure 1, the lights 35 emit light, and the forward camera 31 and the upward camera 32 take images. The forward camera 31 captures images of the front of the movable structure 1, and the upward camera 32 captures images of a ceiling surface of the sewer pipe. These images are used for checking of the state of the sewer pipe.

Further, the two FPV cameras 22 provided, respectively, at the front and back sidefaces of the raised portion 21 of the structure body 2, take moving images of the front and rear of the movable structure 1. These moving images are converted into signals in real time, and transmitted to the inspector by the wireless communication device. The inspector manipulates the remote controller while checking a video displayed on a display based on the signals.

Each of the two ToF sensors 34 provided, respectively, on the left and right sidefaces of the raised portion 21 of the structure body 2, emits a laser beam toward an inner wall surface of the sewer pipe, and then receives a laser beam reflected by the inner wall surface. The information about the emission and receipt of the laser beam is sent as a signal from each of the ToF sensors 34 to the control device inside the structure body 2. The control device performs given computing based on the signal to calculate a distance between the inner wall surface of the sewer pipe and the movable structure 1. The calculated distance is used to control the movable structure 1.

When moving the movable structure 1 in the right-left direction, the fan units 5 are driven, instead of or in addition to the forward propulsion fan 4. As mentioned above, each of the fan units 5 is configured such that an angle formed by the axis 61a thereof with respect to the right-left direction can be adjusted. The inspector can appropriately set the angle according to the sewer pipe to be inspected, the flow of water inside the sewer pipe, etc.

For example, in a situation where the movable structure 1 is required to quickly move in the right-left direction, the inspector may arrange all the fan units 5 such that the axis 61a of each thereof is parallel to the right-left direction, as shown in FIG. 2. FIG. 2 shows airstreams L1, L3 which can be formed, respectively, by the fan units 51, 53 in this arrangement, and airstreams R2, R4 which can be formed, respectively, by the fan units 52, 54 in this arrangement. The airstreams L1, L3 are directed leftwardly, and the airstreams R2, R4 are directed rightwardly. The formation of the airstreams L1, L3 allows the movable structure 1 to quickly move rightwardly, by reaction forces acting on the fan units 51, 53. On the other hand, the formation of the airstreams R2, R4 allows the movable structure 1 to quickly move leftwardly, by reaction forces acting on the fan units 52, 54.

Further, in a situation where the movable structure 1 is required to move in the right-left direction while moving against a relatively fast flow of water in the sewer pipe, the inspector can arrange all the fan units 5 such that the axis 61a of each thereof forms an angle θ with respect to the right-left direction, as shown in FIG. 7. FIG. 7 shows airstreams BL1, BL3 which can be formed, respectively, by the fan units 51, 53 in this arrangement, and airstreams BR2, BR4 which can be formed, respectively, by the fan units 52, 54 in this arrangement. The airstreams BL1, BL3 are directed backwardly and leftwardly, and the airstreams BR2 and BR4 are directed backwardly and rightwardly. The formation of the airstreams BL1, BL3 allows the movable structure 1 to move rightwardly while moving against the flow of water, by reaction forces acting on the fan units 51, 53. On the other hand, the formation of the airstreams BR2, BR4 allows the movable structure 1 to move leftwardly while moving against the flow of water, by reaction forces acting on the fan units 52, 54.

Further, in a situation where the movable structure 1 is required to move in the right-left direction or turn quickly, while moving against a relatively slow flow of water in the sewer, the inspector can arrange the fan units 51, 52 such that the axis 61a of each thereof is parallel to the right-left direction, and arrange the fan units 53, 54 such that the axis 61 a of each thereof forms an angle θ with respect to the right-left direction, as shown in FIG. 8. FIG. 8 shows the airstream L1, BL3 which can be formed, respectively, by the fan units 51, 53 in this arrangement, and the airstream R2, BR4 which can be formed, respectively, by the fan units 52, 54 in this arrangement. The formation of the airstreams L1, BL3 allows the movable structure 1 to move rightwardly or quickly turn rightwardly, while moving against the flow of water, by reaction forces acting on the fan units 51, 53. On the other hand, the formation of the airstreams R2, BR4 allows the movable structure 1 to move leftwardly or quickly turn leftwardly, while moving against the flow of water, by reaction forces acting on the fan units 52, 54.

### <Movement of Movable Structure in Right-Left Direction>

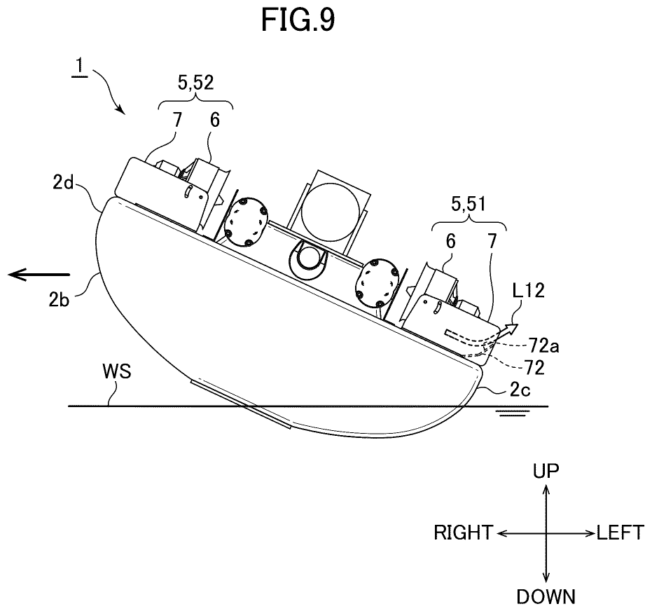

Next, with reference to FIGS. 6 and 9, the movement of the movable structure 1 in the right-left direction will be described in detail. FIG. 9 is an explanatory diagram showing the movable structure 1 which is moving rightwardly. In the movable structure 1 illustrated in FIG. 9, all the fan units 5 are arranged such that the axis 61a of each thereof is parallel to the right-left direction (see FIG. 2).

As shown in FIG. 6, the fan 6 of the fan unit 5 is disposed such that it is spaced apart from the guide surface 72a of the curved plate 72, and the outlet 62b of the duct 62 is oriented toward the guide surface 72a of the fan casing 7. Thus, an airstream L11 generated by the fan 6 is directed in a direction along the axis 61a in the vicinity of the fan 6, but subsequently flows along the guide surface 72a, thereby having increased upward directivity. In this process, the guide surface 72a receives, as a reaction force, a force directed downwardly and outwardly with respect to the structure body 2, as indicated by the arrow F1.

Thus, when the fan units 51, 53 are driven, a portion of the structure body 2 adjacent to the left end 2c thereof receives a force in the direction indicated by the arrow F1 through the fan casing 7. As a result, the movable structure 1 is inclined such that the left end 2c of the structure body 2 is lowered and the right end 2d is raised, as shown in FIG. 9. An airstream L12 flowing along the guide surface 72a after the inclination of the movable structure 1 is directed in a direction closer to a horizontal direction than the airstream L11 illustrated in FIG. 6. This allows the movable structure 1 to move rightwardly using the reaction forces acting on the fan units 51, 53 as a propulsive force.

On the other hand, when the movable structure 1 moves leftwardly, the fan units 52, 54 are driven. In this case, forces received by the guide surfaces 72a of the fan units 52, 54 cause the movable structure 1 to be inclined such that the right end 2d of the structurer body 2 is lowered and the left end 2c is raised.

### <Functions/Effects)

Next, functions/effects based on the configuration of the movable structure 1 will be described.

As described above, the guide surface 72a is disposed at a position offset from the center point CP of the structure body 2 in the right-left direction (i.e., in the width direction of the structure body 2), and configured to change a traveling direction of the airstream generated by the fan 6 to increase the upward directivity of the airstream. According to this configuration, the movable structure 1 can be inclined to reduce the area of a portion of the structure body 2 located underwater. This makes it possible to reduce a water resistance to be received by the structure body 2 when the movable structure 1 moves in the right-left direction.

Further, as a result of increasing the upward directivity of the airstream by the guide surface 72a, the airstream is directed in a direction away from the water surface WS. This suppresses ruffle of the water surface WS and scattering of water droplets which would be otherwise caused by the airstream.

That is, according to the configuration of the movable structure 1, it becomes possible to allow the movable structure 1 to quickly move in the right-left direction, while suppressing water splashing against a device provided on the structure body 2.

In the above embodiment, the fan 6 comprises a propeller 61 configured to rotate about an axis 61a, and a duct 62 covering the periphery of the propeller 61.

According to this configuration, the duct 62 can suppress spreading of an airstream generated by the propeller 61, and efficiently direct the airstream to the guide surface 72a. As a result, it becomes possible to reliably incline the movable structure 1 and quickly move the movable structure 1 in the right-left direction.

In the above embodiment, the movable structure 1 further comprises an angle adjustment mechanism configured to enable the fan 6 to be turned with respect to the structure body 2 to thereby adjust an angle formed between the right-left direction and the axis 61a of the fan 6.

According to this configuration, it is possible to adjust the directivity of the airstream generated by the fan 6 to adjust the direction of a reaction force to be received by the fan 6. As a result, it becomes possible to appropriately adjust the direction of a propulsive force, according to the flow of water around the movable structure 1, etc.

In the above embodiment, the fan 6 is provided plurally, and the angle adjustment mechanism is provided plurally, wherein: the plural fans 6 include a fan 6 (first fan) of each of two fan units 51, 52 disposed on a front end 2e side of the structure body 2 with respect to the center point CP of the structure body 1, and a fan 6 (second fan) of each of two fan units 53, 54 disposed on a rear end 2f side of the structure body 2 with respect to the center point CP of the structure body 2; and the plural angle adjustment mechanisms include a first angle adjustment mechanism for adjusting an angle formed between the right-left direction and an axis 61a of the fan 6 of each of the fan units 51, 52, and a second angle adjustment mechanism for adjusting an angle formed between the light-left direction and an axis 61a of the fan 6 of each of the fan units 53, 54, independently of the first angle adjustment mechanism.

According to this configuration, it is possible to more finely adjust the directivity of the airstream generated by each fan 6 to adjust the direction of a reaction force to be received by each fan 6. As a result, it becomes possible to further appropriately adjust the direction of the propulsive force according to the flow of water around the movable structure 1, etc.

In the above embodiment, the movable structure 1 further comprises a fan casing 7 which includes the guide surface 72a, and fixes the fan 6 to make up a fan unit 5, wherein the angle adjustment mechanism is configured to enable the fan unit 5 to be turned with respect to the structure body 2.

According to this configuration, the fan unit 5 can be turned by the angle adjustment mechanism, without changing a relative positional relationship between the fan 6 and the guide surface 72a. As a result, it becomes possible to direct the airstream generated by the fan 6 to the guide surface 72a efficiently and appropriately, regardless of the angle formed between the right-left direction and the axis 61a of the fan 6.

In the above embodiment, the fan casing 7 is configured to cover the periphery of a pathway P between the fan 6 and the guide surface 72a.

According to this configuration, the fan casing 7 can suppress spreading of the airstream generated by the fan 6 to efficiently direct the airstream to the guide surface 72a. As a result, it becomes possible to reliably incline the movable structure 1 and quickly move the movable structure 1 in the right-left direction.

### 2nd Embodiment

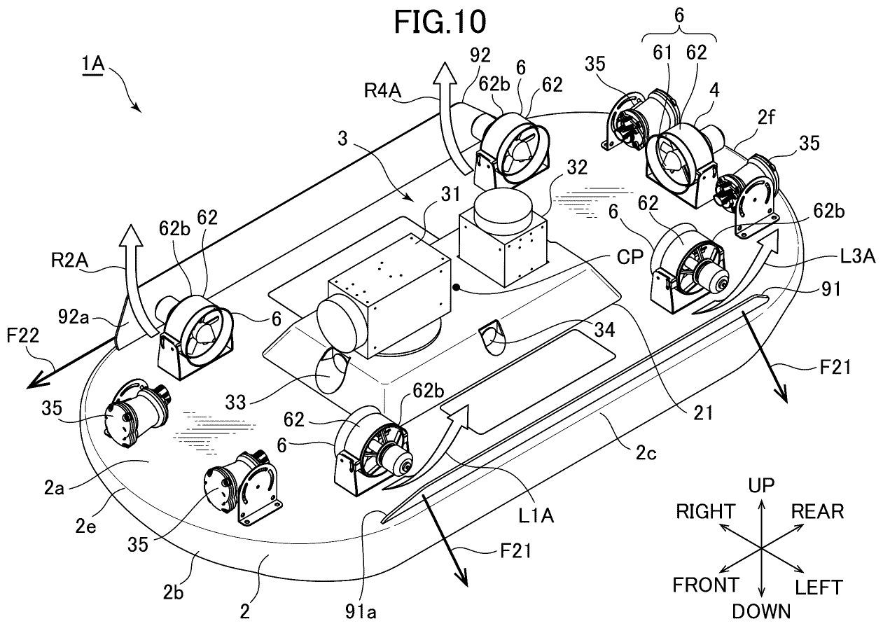

Next, with reference to FIG. 10, a movable structure 1A of a second embodiment will be described. FIG. 10 is a perspective view showing the movable structure 1A as viewed obliquely from the front side thereof. The movable structure 1A is configured to move inside a non-illustrated sewer pipe, and used to acquire information about the sewer pipe, as with the first embodiment. The configuration of the movable structure 1A is different from the first embodiment in terms of guide plates 91, 92 thereof, etc. In the movable structure 1A, the same element or component as that of the first embodiment is assigned with the same reference code, and its description will be omitted as appropriate.

Each fan 6 of the movable structure 1A is mounted on an upper surface 2a of a structure body 2 of the movable structure 1A without using a fan casing 7. A non-illustrated angle adjustment mechanism is provided between the upper surface 2a and each of four fans 6 other than a forward propulsion fan 4. This makes it possible to adjust an angle formed by an axis 61a of each of the four fans 6 with respect to the right-left direction, as with the first embodiment.

Further, two guide plates 91, 92 are provided in the vicinity of a left end 2c and a right end 2d (see FIG. 1) of the structure body 2 of the movable structure 1A, respectively. The guide plate 91 extends upwardly and leftwardly from the vicinity of the left end 2c, and has a guide surface 91a. The guide plate 92 extends upwardly and rightwardly from the vicinity of the right end 2d, and has a guide surface 92a. Each of the four fans 6 other than the forward propulsion fan 4 is spaced apart from the guide surface 91a or the guide surface 92a, and is disposed such that an outlet 62b of a duct 62 is oriented toward the guide surface 91a or the guide surface 92a.

Each of four airstreams L1A, L3A, R2A, R4A generated by the four fans 6 other than the fan 4 for the forward propulsion fun 4 flows along the guide surface 91a or the guide surface 92a, thereby having increased upward directivity. In this process, the guide surface 91a or the guide surface 92a receives, as a reaction force, a force directed downwardly and outwardly with respect to the structure body 2, as indicated by the arrow F21 or the arrow F22.

Thus, a portion of the structure body 2 adjacent to the left end 2c or the right end 2d thereof receives a force in the direction indicated by the arrow F21 or the arrow F22 through the guide plate 91 or the guide plate 92. As a result, the movable structure 1 is inclined such that one of the left end 2c and the right end 2d of the structure body 2 is lowered and the other is raised. An airstream flowing along the guide surface 91a or the guide surface 92a after the inclination of the movable structure 1 is directed in a direction close to a horizontal direction. This allows the movable structure 1 to move rightwardly or leftwardly using the reaction forces acting on the fans 6 as a propulsive force.

The embodiments described above are intended to facilitate understanding of the present invention, but not intended to be used to limitedly construe the present invention. Each element or component of the embodiments and its location, material, conditions, shape, size, etc., are not limited to those exemplified above, but may be appropriately changed or modified.

### LIST OF REFERENCE SIGNS

1: movable structure
2: structure body
5, 51 to 55: fan unit
6: fan
61: propeller
61a: axis
62: duct
7: fan casing
711 to 713: holes 711-713 (angle adjustment mechanism)
72a, 91a, 92a: guide surface
81 to 83: screws (angle adjustment mechanism)
CP: center point
WS: water surface

What is claimed is:

1. A movable structure configured to move on a water surface, comprising:
a structure body floatable on the water surface;
a fan provided on the structure body and capable of generating an airstream directed outwardly from the structure body in a width direction of the structure body; and
a guide surface provided on the structure body and configured to guide the airstream generated by the fan to thereby receive a reaction force, the guide surface being disposed at a position offset from a center point of the structure body in the width direction, and configured to change a traveling direction of the airstream generated by the fan to increase an upward directivity of the airstream, whereby the guide surface receives a downward force.

2. The movable structure as recited in claim 1, wherein the fan comprises: a propeller configured to rotate about an axis; and a duct covering a periphery of the propeller.

3. The movable structure as recited in claim 1, further comprising an angle adjustment mechanism configured to enable the fan to be turned with respect to the structure body to thereby adjust an angle formed between the width direction and an axis of the fan in top plan view.

4. The movable structure as recited in claim 3, wherein the fan is provided plurally, and the angle adjustment mechanism is provided plurally, wherein:
the plural fans include a first fan disposed on a front end side of the structure body with respect to the center point of the structure body, and a second fan disposed on a rear end side of the structure body with respect to the center point of the structure body; and
the plural angle adjustment mechanisms include a first angle adjustment mechanism for adjusting an angle formed between the width direction and an axis of the first fan, and a second angle adjustment mechanism for adjusting an angle formed between the width direction and an axis of the second fan, independently of the first angle adjustment mechanism.

5. The movable structure as recited in claim 4, further comprising a fan casing which includes the guide surface, and fixes the fan to make up a fan unit, wherein the angle adjustment mechanism is configured to enable the fan unit to be turned with respect to the structure body.

6. The movable structure as recited in claim 5, wherein the fan casing is configured to cover a periphery of a pathway between the fan and the guide surface.

7. A movable structure configured to move on a water surface, comprising:
a structure body floatable on the water surface;
a fan provided on the structure body and capable of generating an airstream directed outwardly from the structure body in a width direction of the structure body; and
a guide surface provided on the structure body and configured to guide the airstream generated by the fan to thereby receive a reaction force, the guide surface being disposed at a position offset from a center point of the structure body in the width direction, and configured to extend outwardly from the structure body in the width direction, and upwardly.

8. The movable structure as recited in claim 7, comprising a plate disposed to be inclined with respect to an upper surface of the structure body, wherein the guide surface is formed by the plate.

9. The movable structure as recited in claim 7, wherein the fan comprises: a propeller configured to rotate about an axis; and a duct covering a periphery of the propeller.

10. The movable structure as recited in claim 7, further comprising an angle adjustment mechanism configured to enable the fan to be turned with respect to the structure body to thereby adjust an angle formed between the width direction and an axis of the fan in top plan view.

11. The movable structure as recited in claim 10, wherein the fan is provided plurally, and the angle adjustment mechanism is provided plurally, wherein:
the plural fans include a first fan disposed on a front end side of the structure body with respect to the center point of the structure body, and a second fan disposed on a rear end side of the structure body with respect to the center point of the structure body; and
the plural angle adjustment mechanisms include a first angle adjustment mechanism for adjusting an angle formed between the width direction and an axis of the first fan, and a second angle adjustment mechanism for adjusting an angle formed between the width direction and an axis of the second fan, independently of the first angle adjustment mechanism.

12. The movable structure as recited in claim 11, further comprising a fan casing which includes the guide surface, and fixes the fan to make up a fan unit, wherein the angle adjustment mechanism is configured to enable the fan unit to be turned with respect to the structure body.

13. The movable structure as recited in claim 12, wherein the fan casing is configured to cover a periphery of a pathway between the fan and the guide surface.
